(19) United States
(12) Patent Application Publication
(10) Pub. No.: US 2005/0187798 A1
(43) Pub. Date: Aug. 25, 2005

(54) Systems and methods for providing insurance in conjunction with a data protection service

(75) Inventors: John Paul Conn, San Marino, CA (US); Thomas J. O'brien, Carlsbad, CA (US)

Correspondence Address: HOGAN & HARTSON L.L.P., 500 S. GRAND AVENUE, SUITE 1900, LOS ANGELES, CA, 90071-2611, US

(73) Assignee: VIRTUAL BACKUP, INC.

(21) Appl. No.: 10/783,638

(22) Filed: Feb. 20, 2004

(51) Int. Cl. G06F 17/60

(52) U.S. Cl. 705/4

(57) ABSTRACT

An agreement is created between a first entity and a second entity under which the second entity agrees to provide data protection services for use by a third entity. An insurance agreement is also created, under which the first entity agrees to insure the third entity against losses caused by data loss experience by the third entity. The insurance agreement may require the third entity to use the second entity's data protection service, and recovery under the insurance agreement by the third entity may be made contingent upon this use. A backup copy of the third entity's data is created and maintained at a location controlled by the second entity. If the third entity suffers a data loss, a replacement copy of the data is generated from the backup copy. In some embodiments the insurance and the data protection services may be provided by the same entity.

### BACKGROUND OF THE INVENTION

The invention provides business methods for providing insurance in conjunction with a data protection service.

Business owners' insurance policies are insurance policies that protect business owners from various losses in connection with their businesses. Some business owners' insurance policies include provisions that protect the business owner in the event of business interruptions. According to these provisions, the business owner is typically compensated by the insurance company for losses that occur when the business owner is unable to operate his business due to some unforeseen contingency. This can include situations where data that is vital to the business owner is lost. A typical business owner insurance policy would compensate the business owner until the data could be recovered, reconstructed, or otherwise restored. Insurance companies have an interest in reducing or eliminating the time it takes insured business owners to replace lost data, since this can reduce the time over which the insurance company is required to pay for the business interruption.

Losses suffered in recent terrorist attacks and natural disasters helped draw attention to the problems associated with conventional insurance for insuring against economic losses arising out of lost data. Many companies either had their own data back up systems or utilized a third entity data protection service. Remarkably, these companies were up and running only a few days after the attacks. To the extent that these businesses had business interruption insurance, their insurance companies were required to pay for “business interruption” losses incurred during the few days that business was interrupted while setting up computer systems at alternative locations. By contrast, for other companies that were not protected by some form of data protection technology, insurance companies were required to pay for business losses incurred during a much longer time period while business was interrupted during restoration or reconstruction of data.

Companies have a strong incentive to pay the premiums charged for “business interruption insurance.” In many cases, though, the insured companies fail to take the steps necessary to protect their data such as entering into a contract with a data protection provider. Small businesses and individuals often cannot afford their own data protection technology, and fail to appreciate the importance of contracting with third parties that provide such data protection services. Many individuals and small business owners carry computer insurance that protects the insured's computer hardware and software in the event of damage or destruction. These types of insurance, though, do not cover the data, for example, that is stored in the hardware and utilized by the software. Thus, when data is lost and this loss interrupts business, the insurance companies may end up paying business interruption claims for a much longer period while data is restored or reconstructed.

A need exists for improved systems and methods for providing insurance and data protection services to data owners.

### SUMMARY OF THE INVENTION

A business method for providing insurance in conjunction with a data protection service includes the creation of an agreement between a first entity and a second entity under which the second entity agrees to provide data protection services for use by a third entity. An insurance agreement is also created, under which the first entity agrees to insure the third entity against losses caused by data loss experience by the third entity. The insurance agreement preferably requires the third entity to use the second entity's data protection service, and recovery under the insurance agreement by the third entity may be made contingent upon this use. The insurance agreement may specify the type or level of services that the third entity is required to use. In some embodiments, the second entity provides a data backup service in which a backup copy of the third entity's data is created and maintained at a location controlled by the second entity. If the third entity suffers a data loss, a further copy of the data is generated from the backup copy. The first entity may pay the second entity for providing data protection services to the third entity. The first entity may, moreover, elect not to charge the third entity any special premium or additional charge for providing the data protection service, beyond the usual premium that the first entity would ordinarily charge for providing its insurance without the provision of the data protection services.

The invention thus can provide a loss mitigation tool for an insurer that provides an insured with insurance against economic losses incurred due to a loss of data by the insured. An insurance agreement between the insurer and the insured can provide this insurance to the insured, and can further allow the insured to use a data protection service. The insurance agreement may require the insured to install, set up, and use the data protection service.

An insurance system is thus provided which includes a data protection service provider, an insurer, and an insured that is insured by the insurer against losses arising out of the loss of the insured's data, and in which the insured is required to use a data protection service offered by the provider.

In some embodiments, the insured is not charged for the data protection services, the service provider instead being compensated by the insurer. In other embodiments the insured purchases the data protection service directly from the provider, but the insurer discounts the premium it would ordinarily charge for insuring the insured against losses arising from loss of its data. In still other embodiments, the data protection service provider may pay the insurer for requiring the use of its services, or the provider may agree to provide its services to the insurer's insured at a price that is discounted in comparison to what the provider would normally charge for services of that type.

Although in many embodiments the insurance and the data protection services will be provided to the data owner by separate entities, the insurance and data protection services may in some embodiments be provided by one single entity provider.

### BRIEF DESCRIPTION OF DRAWINGS

The following discussion may be best understood with reference to the various drawings, which form a part of this disclosure.

FIG. 1 is a flow chart illustrating methods according to embodiments of the invention.

FIG. 2 is a block diagram further illustrating the methods of FIG. 1.

FIG. 3 is a flow chart illustrating methods according to alternative embodiments.

FIG. 4 is a block diagram further illustrating the methods of FIG. 3.

FIG. 5 is a block diagram that illustrates other alternative embodiments.

### DETAILED DESCRIPTION OF THE PREFERRED EMBODIMENTS

The invention is described here with reference to the accompanying drawings, in which preferred embodiments of the invention are shown. The invention may, however, be embodied in many different forms and should not be construed as limited to these examples.

When an element such as a block or unit is shown in the figures connected to another element, it can be directly connected to the other element or intervening elements may also be present. Terms such as “entity” and “data protection service” can include one or more of the indicated element.

“Data” includes any information that has value to its owner. “Insurance” is a financial arrangement for redistributing the costs of unexpected losses according to a contract in which an insurer agrees to compensate an insured for those losses. A “loss” is an undesired, unplanned reduction in economic value. “Data loss” can include, for example, events in which no current copy of the data exists, or events in which only a partial but possibly or certainly corrupted copy of the data is available.

A “data protection service” can include data protection tools and techniques for reproducing information. These can include functions such as copying data and maintaining backups of data at previous times and dates. Particular data protection services might include local data mirroring, remote data mirroring, operating-system-supported data object replication, or file-by-file data archiving, and these might be supplemented by virus scanning or other data protection services. Such data protection services may be provided at a single facility or at a plurality of facilities, locally at the data owner's site, or remotely at another location.

The methods and systems described here can apply in situations where a first entity insures a third entity via an insurance agreement. The first entity may purchase a data protection service from a second entity for use by customers of the first entity. Insurance agreements according to these methods can provide insurance to the third entity and include, among other things, provisions for providing insurance to protect against economic losses arising out of the insured's loss of data.

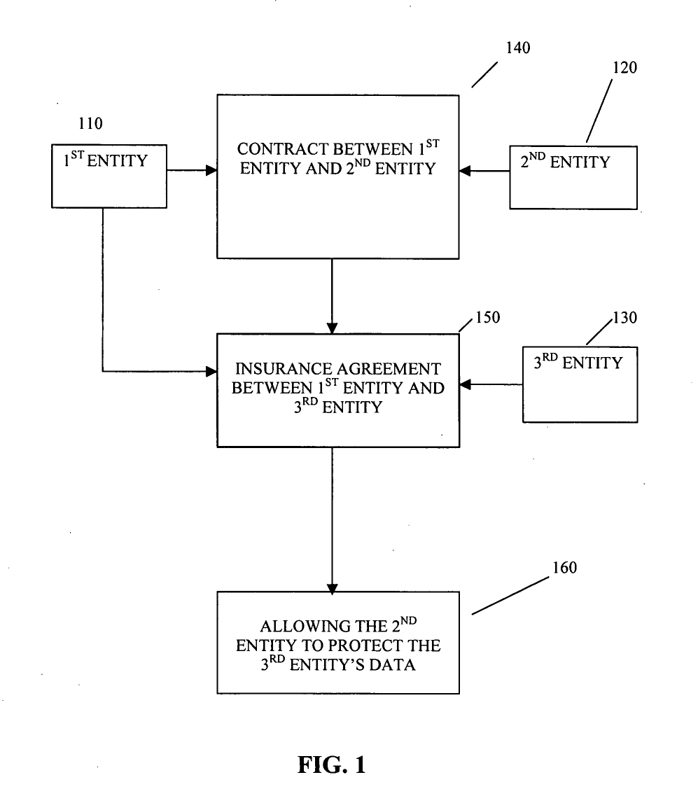

FIG. 1 is a flow chart illustrating one method according to the invention. Block 140 represents a contract between a first entity 110 and a second entity 120. This contract can include an agreement obligating the second entity to provide data protection services to a third entity 130. The second entity could, for example, create a backup copy of the third entity's data and retain it at the second entity's location. If the third entity's data is lost, the second entity can restore the data from the backup copy. The second entity may provide an online data backup service in which the third entity's data is transmitted to a location controlled by the second entity over the Internet, a private network or similar means for copying and backup by the second entity. Virtual Backup, Inc. is a provider of such services.

Block 150 represents an insurance agreement between the first entity 110 and the third entity 130. The insurance agreement obligates the first entity 110 to insure the third entity against losses to the third entity's data or business interruption losses that arise from such data loss. The insurance agreement permits, and may require, the third entity to use the data protection service provided by the second entity 120. The insurance agreement might, for example, require the third entity to install, set up, and use the data protection services. Recovery under the policy can be made contingent, in whole or in part, on the third entity's compliance with these requirements. If, for example, the third party fails to use or fails properly to cooperate in the use of the data protection services, then the third party's recovery under the policy might be eliminated or reduced. Block 160 represents the second entity's provision of data protection services to protect the third entity's data.

The first entity 110 insures the third entity 130 against losses arising from its loss of data. These losses can be mitigated or minimized where the second entity 120 is able to restore the third entity's data quickly and completely after any data loss. The first entity pays or otherwise compensates the second entity for its data protection services, but may elect not to charge the third entity any special or additional premium beyond those normally charged for business interruption coverage or other typical insurance. Including data protection services as part of the insurance agreement at no additional premium encourages the insured third entity to use the data protection services. This reduces the losses suffered by the third entity insured when data is lost, and thereby reduces the amount the first entity insurer must pay out as compensation for data loss and business interruption claims. The third entity's use of the data protection services can be made a condition of the insurance policy. The first entity insurer will not make good the third entity's losses unless the third entity has used the second entity's data protection services as required. The first entity insurer can increase the likelihood that the third entity will use those services, and losses that might otherwise have occurred can be mitigated by the presence and use of the data protection service.

The insurance contract between the first entity and the third entity may be a “stand-alone” insurance contract providing for protection against economic losses arising out a loss of the third entity's data. Loss mitigation provisions might also be incorporated into and sold along with other protections as part of a larger contract or set of contracts. Such provisions might be incorporated, for example, into a contract for “valuable papers” coverage that would protect the third entity from economic losses that might otherwise arise out of the loss of information stored in paper records as well as the computerized data that are the subject of the data protection methods described in this document. Such data protection provisions might also be incorporated into a company's general business insurance policy, in connection, for example, with the company's business interruption insurance provisions.

Data protection insurance like that described in this document might be also be included in provisions for insurance such as director's and officer's (D&O) insurance. In the event of a claim against the directors or officers of a corporation, the provisions described here would ensure that critical records required to defend against that claim were available for that defense, and compensate the insured entity in the event they were not. Similar protections might be made available in connection with professional liability policies of the type commonly purchased by doctors, lawyers, and the like. The data protection provisions help to ensure that patient or client records are present and available to defend against claims, and if the data are not available, to mitigate the harm that might arise out of the data's unavailability.

Although in many embodiments the insurance and the data protection services will be provided to the data owner by separate entities, the insurance and data protection services may in other embodiments be provided by one single entity provider.

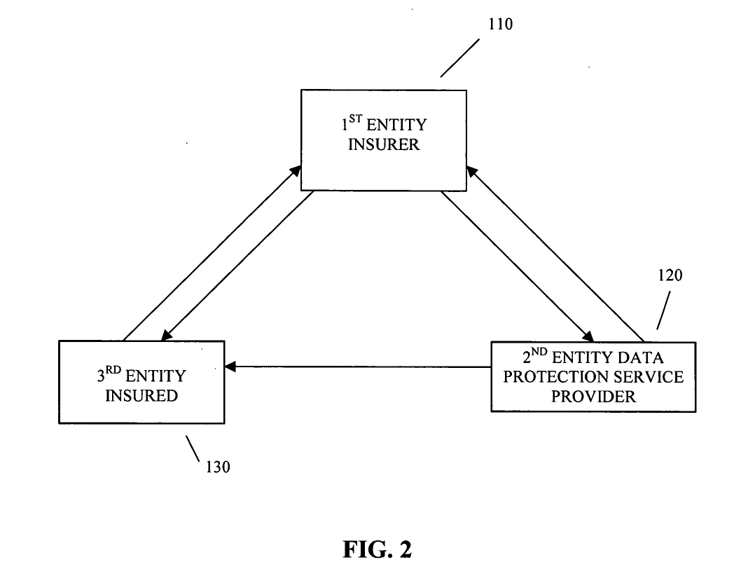

FIG. 2 illustrates a loss mitigation system. The arrow extending from the first entity insurer 110 to the third entity insured 120 represents insurance provided by the first entity, and in particular, compensation paid by the first entity to the third entity for losses that arise from data loss. The arrow that extends back from the third entity insured to the first entity insurer represents the premium or other compensation paid by the insured in return for the insurance.

The arrow extending from the second entity data protection service 120 to the first entity insurer 110 represents the data protection service's agreement with the insurer to allow the third entity insured 130 to use the data protection service. In essence, the first entity insurer 110 purchases data protection services on behalf of its insured customers. This can be viewed as the purchase of a license for the benefit of the third entity insured, and this license is represented by the arrow from the second entity data protection service to the third entity insured. The first entity insurance provider 110 compensates the second entity 120 for providing the data protection service to the insured 130. This compensation is represented by the arrow from the first entity insurer to the data protection service.

Significantly, there is no arrow in this figure from the third entity insured 130 to the second entity data protection service 120. The third entity does not make any separate payment to the data protection service for the use of its service. Provision of such services is part of the third entity's agreement with its insurer, and payment for the services is from the insurer to the service provider.

With conventional insurance plans, the insured may or may not purchase data protection services. Many insureds will forgo the extra expense of acquiring such services; others may cut costs by contracting with services of dubious quality or effectiveness. Even when an insured does purchase data protection services, the insured may not take all of the steps required—such as installing required software, using it as directed, or making backups at the recommended frequency—to use the service effectively.

In the scheme described here, though, the insured 130 does not pay anything directly to the data protection service provider 120, and the insurer 110 typically will not charge any additional or special premium in exchange for the insurer's arranging for the data protection service. The insured, moreover, can be required by the terms of the policy to cooperate with the service to install, maintain, and use the data protection service to provide the specified protection for the data. If the insured fails to do what is required, recovery may be denied by the insurer in the event of data loss.

An insured thus has a very substantial incentive to maintain and use the data protection service. By increasing the number of insureds that use the data protection service, and by ensuring that the data protection service provides a service of acceptable quality, the insurance provider can expect to reduce the amounts it must pay out in claims for data loss and business interruption pursuant to the insurance agreement.

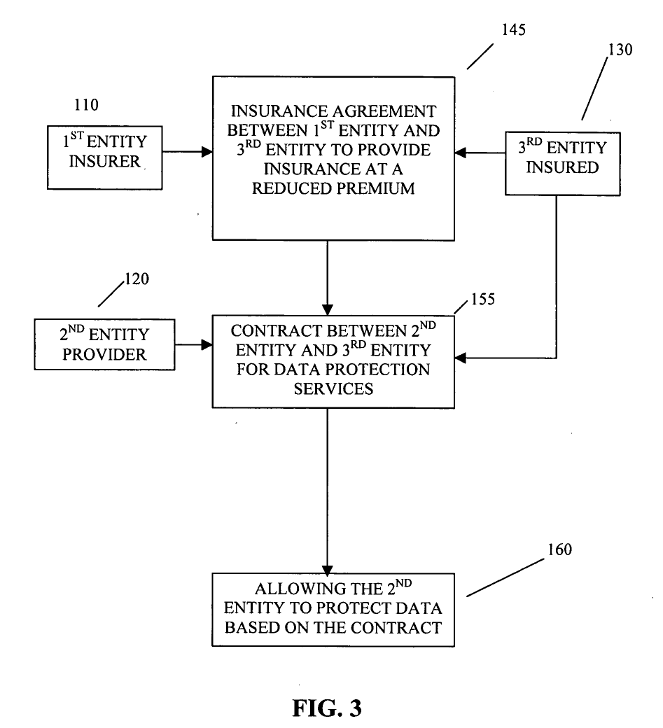

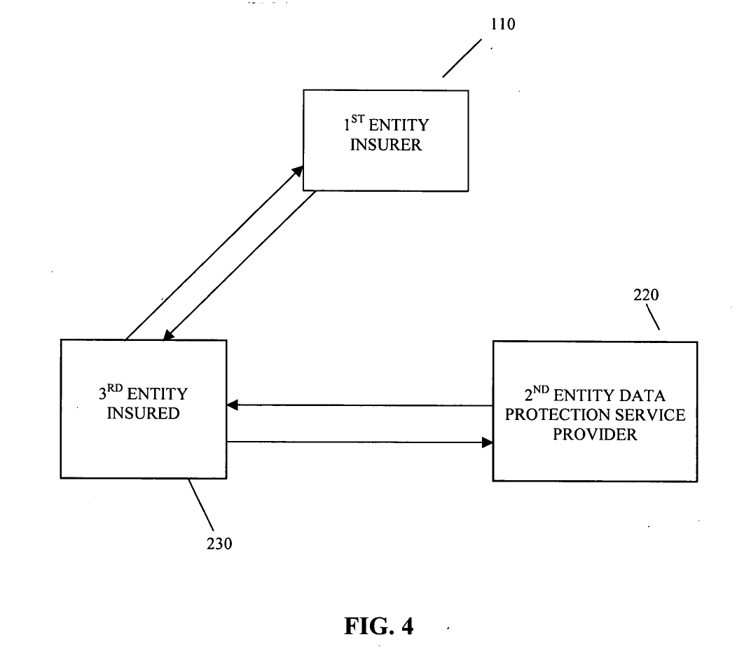

FIGS. 3 and 4 illustrate a variant in which an “offset method” is utilized to pay for the data protection services. In this method, the first entity insurer 110 (see FIG. 3) provides insurance 145 to the third entity insured 130 for a premium that is reduced in comparison with the premium ordinarily charged for the same level of insurance. To qualify for the reduced premium, the third entity 130 must agree to purchase data protection services 160—the agreement between the third entity insured and the second entity data protection service provider 120 being represented by block 155 in FIG. 3. Though the third entity must pay the second entity for the data protection services, the third entity's expense in doing so can be offset by the reduced insurance premium charged by the first entity insurer.

In FIG. 4, the arrow from the first entity insurer 110 to the third entity insured 130 represents the insurance provided by the insurer to the third entity. The arrow from the insured to the insurer represents the premium the third entity pays to purchase the insurance. This premium is reduced in comparison with what the insurer would normally have charged for the insurance. The reduced premium is typically offered on the condition that the third entity purchase data protection services from a second entity data protection service provider 120. The identity of the provider and the type and degree of data protection services may be specified in the insurance agreement.

The purchase by the third entity insured 130 of data protection services from the data protection service provider 120 is illustrated in FIG. 4. The arrow from the second entity data protection service provider to the third entity insured represents the provision of the data protection services by the provider. The arrow from the insured to the service provider represents the insured's payment for those services.

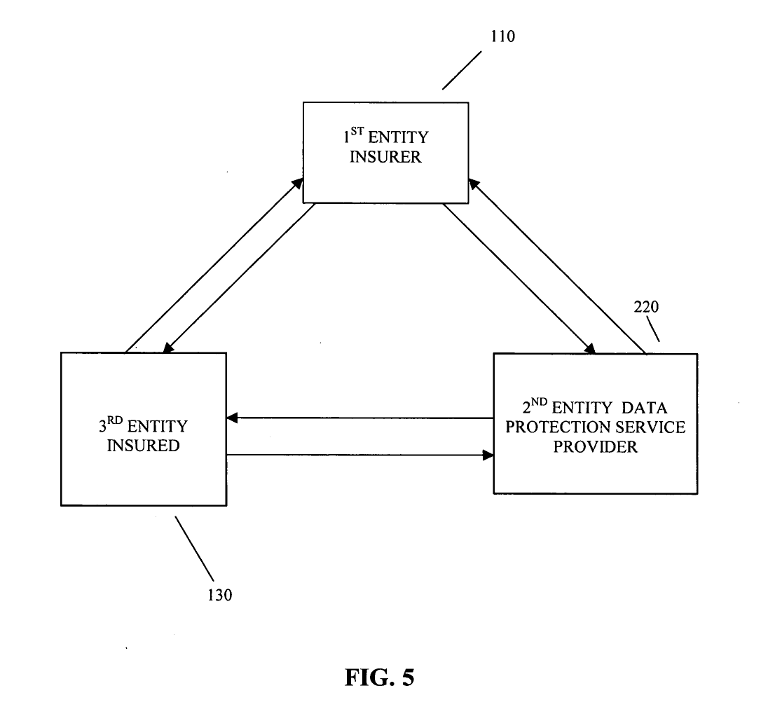

FIG. 5 illustrates another variant. This method includes the same elements as those of the variant illustrated in FIGS. 3 and 4. This variant, though, includes a further agreement between the first entity insurer 110 and the second entity data protection service provider 120. In FIG. 5, the arrow from the first entity insurer to the second entity data protection service provider represents a promise by the insurer to include in its policies a provision requiring its insureds to purchase data protection services from that provider. The arrow from the service provider to the insurer represents a promise by the provider to pay the insurer money or other compensation for requiring use of the provider's services, or to provide its services to the insurer's insured at a discount to what it would normally charge for the same level of service.

While aspects of the invention have been described in terms of certain preferred embodiments, those of ordinary skill in the art will appreciate that various changes and additions might be made without varying from the basic principles of the invention. Aspects of the present invention can be implemented in a variety of implementations, and are not limited to any one particular implementation. Moreover, although the aspects of the invention described herein are described with reference to a first entity insurer, a second entity data protection service, and a third entity insured, the parties to the methods described here need not be formally denominated as such, so long as they act as described in the appended claims. The invention could also be embodied in insurance models in which other parties are present that act as brokers, agents, contractors, vendors, or other intermediaries in transactions between an insurer, an insured, and a data protection service provider. The inventions are thus not limited to the specific and exemplary embodiments described in this document. The scope of the invention should instead be determined from the appended claims, including the full scope of equivalents to which those claims are legally entitled.

1. A business method comprising:
creating an agreement between a first entity and a second entity to provide a data protection service to a third entity, wherein the first entity purchases a data protection service from the second entity for use by the third entity; and
creating an insurance agreement between the first entity and the third entity, wherein the insurance agreement provides that the first entity will insure the third entity for losses arising out of lost data, wherein the insurance agreement authorizes the third entity to use the data protection service provided by the second entity.

2. A method according to claim 1, wherein the insurance agreement requires the third entity to use the data protection service provided by the second entity.

3. A method according to claim 1, wherein the first entity's insurance of the third entity against losses arising of data loss is at least partially contingent upon the third entity's using predetermined services provided by the second entity.

4. A method according to claim 3, wherein the predetermined services are specified in the insurance agreement.

5. A method according to claim 1, wherein the identity of the second entity is specified in the insurance agreement.

6. A method according to claim 1, wherein the data protection service is a data backup service, and further comprising:
creating a backup copy of the third entity's data at a location controlled by the second entity; and
generating, after a loss of the third entity's data, a further copy of the third entity's data from the backup copy.

7. A method according to claim 6, wherein the data backup service is an online data backup service.

8. A method according to claim 1, and further comprising providing compensation from the first entity to the second entity in return for the second entity's provision of data protection services to the third entity.

9. A method according to claim 8, wherein the third entity is not required to pay a premium to the first entity, beyond what the first entity would ordinarily charge for providing insurance without the provision of data protection services.

10. A loss mitigation tool for an insurer that insures an insured entity, wherein the insurer purchases a data protection service from a second entity for use by the insured entity, the loss mitigation tool comprising:
an insurance agreement between the insurer and the insured entity, wherein the insurance agreement provides insurance to the insured entity for losses arising out of lost data, and wherein the insurance agreement includes a data protection provision under which the insured entity is allowed to use the data protection service.

11. A loss mitigation tool according to claim 10, wherein the insurance agreement requires the insured entity to use the data protection service provided by the second entity.

12. A loss mitigation tool according to claim 10, wherein the insurance agreement makes the insured entity's recovery from the insurer for losses arising out of lost data at least partially contingent upon the insured entity's use of the predetermined data protection services provided by the second entity.

13. A loss mitigation tool according to claim 10, wherein the identity of the second entity is specified in the insurance agreement.

14. A loss mitigation tool according to claim 10, wherein the data protection service is a data backup service, and the data backup service comprises:
apparatus operable to create a backup copy of the insured entity's data at a location controlled by the second entity; and
apparatus operable to generate a copy of the insured entity's data from the backup copy.

15. A loss mitigation tool according to claim 14, wherein the data backup service is an online data backup service.

16. A loss mitigation tool according to claim 10, wherein the insurer compensates the second entity for providing the data protection service to the insured entity, and wherein the insured entity is not required to pay compensation for the provision of the data protection service beyond what the insurer would ordinarily charge for insuring the insured entity against losses arising out of lost data.

17. A loss mitigation tool according to claim 16, wherein the insurance agreement includes a condition that the insured entity is responsible for using the data protection service if the insured entity is to recover under the insurance agreement, and wherein the insurance is not provided if the condition is not satisfied.

18. An insurance system comprising:
a data protection service provider;
an insurer, wherein the insurer acquires data protection services from the data protection service provider for use by the insurer's insureds; and
an insured that is insured by the insurer against losses arising out of lost data, wherein an insurance agreement between the insurer and the insured allows the insured to use the data protection services acquired by the insurer.

19. An insurance system according to claim 18, wherein the insurance agreement requires the insured to use the data protection service provided by the data protection service provider.

20. An insurance system according to claim 18, wherein the insurance of the insured against losses arising out of lost data is at least partially contingent upon the insured's using predetermined data protection services provided by the data protection service provider.

21. An insurance system according to claim 20, wherein the predetermined data protection services are specified in the insurance agreement.

22. An insurance system according to claim 18, wherein the data protection service provider provides a data backup service, and further comprising:
apparatus operable to create a backup copy of the insured's data at a location controlled by the data protection service provider; and
apparatus operable to generate, after a loss of the insured's data, a further copy of the insured's data from the backup copy.

23. An insurance system according to claim 22, wherein the data backup service is an online data backup service.

24. An insurance system according to claim 18, wherein the insurer compensates the data protection service provider for allowing the insured to use the data protection services.

25. An insurance system according to claim 24, wherein the insured is not required to pay a premium to the insurer, beyond what the insurer would ordinarily charge for providing insurance without the provision of data protection services.

26. A business method comprising:
creating an insurance agreement between an insurer and an insured, wherein the insurance agreement provides that the insurer will insure the insured for losses arising out of lost data, and wherein the insurance agreement requires the insured to use a data protection service provided by a data protection service provider; and
creating a data protection service agreement between the insured and the data protection service provider, wherein the data protection service agreement provides that the data protection service provider will provide a data protection service to the insured.

27. The method of claim 26, wherein the insurance agreement provides that the insurer will charge the insured a reduced premium for the insurance, contingent upon the insured's using the data protection service.

28. A method according to claim 26, wherein the identity of the data protection service provider and the nature of the data protection service are specified in the insurance agreement.

29. A method according to claim 26, wherein the data protection service is a data backup service, and further comprising:
creating a backup copy of the insured's data at a location controlled by the data protection service provider; and
generating, after a loss of the insured's data, a further copy of the insured's data from the backup copy.

30. A method according to claim 29, wherein the data backup service is an online data backup service.

31. A method according to claim 26, wherein the insured's recovery for losses arising out of lost data is at least partially contingent upon the insured's use of the data protection service.

32. A business method comprising:
creating an insurance agreement between an insurer and an insured, wherein the insurance agreement provides that the insurer will insure the insured for losses arising out of lost data, and wherein the insurance agreement requires the insured to use a data protection service provided by a data protection service provider;
creating a data protection service agreement between the insured and the data protection service provider, wherein the data protection service agreement provides that the data protection service provider will provide a data protection service to the insured; and
creating an agreement between the insurer and the data protection service provider that provides for at least one of:
compensation from the data protection service provider to the insurer for the insurer's requirement that the insured use the data protection service; and
a discount in the amount normally charged by the data protection service provider for providing the data protection service.

33. A method according to claim 32, wherein the insurance agreement requires the insured to purchase the data protection service from the data protection service provider.

34. A method according to claim 32, wherein the insured's recovery for losses arising out of lost data is at least partially contingent upon the insured's use of the data protection service.

35. A method according to claim 32, wherein the data protection service is a data backup service, and further comprising:
creating a backup copy of the insured's data at a location controlled by the data protection service provider; and
generating, after a loss of the insured's data, a further copy of the third entity's data from the backup copy.

36. A method according to claim 35, wherein the data backup service is an online data backup service.

37. A business method comprising:
creating an agreement between a provider and a data owner wherein the agreement includes:
an data protection provision under which the provider agrees to provide a data protection service to the data owner; and
an insurance provision under which the provider agrees to insure the data owner for losses arising out of data loss by the data owner.

38. A method according to claim 37, wherein the insurance provision requires the data owner to use the data protection service.

39. A method according to claim 37, wherein the provider's insurance of the data owner against losses arising of data loss is at least partially contingent upon the data owner's using predetermined data protection services provided by the provider.

40. A method according to claim 39, wherein the predetermined services are specified in the agreement.

41. A method according to claim 37, wherein the data protection service is a data backup service, and further comprising:
creating a backup copy of the data owner's data at a location controlled by the provider; and
generating, after a loss of the data owner's data, a further copy of the data owner's data from the backup copy.

42. A method according to claim 41, wherein the data backup service is an online data backup service.

43. A method according to claim 37, wherein the data owner is not required to pay a premium to the provider, beyond what the provider would ordinarily charge for providing insurance without the provision of data protection services.

44. A loss mitigation tool for an insurer that insures an insured entity, wherein the insurer provides a data protection service for use by the insured entity, the loss mitigation tool comprising:
an insurance agreement between the insurer and the insured entity, wherein the insurance agreement provides insurance to the insured entity for losses arising out of lost data, and wherein the insurance agreement includes a data protection provision under which the insured entity is allowed to use the data protection service.

45. A loss mitigation tool according to claim 44, wherein the insurance agreement requires the insured entity to use the data protection service.

46. A loss mitigation tool according to claim 44, wherein the insurance agreement makes the insured entity's recovery from the insurer for losses arising out of lost data at least partially contingent upon the insured entity's use of the predetermined data protection services.

47. A loss mitigation tool according to claim 44, wherein the data protection service is a data backup service, and the data backup service comprises:
apparatus operable to create a backup copy of the insured entity's data at a location controlled by the insurer; and
apparatus operable to generate a copy of the insured entity's data from the backup copy.

48. A loss mitigation tool according to claim 47, wherein the data backup service is an online data backup service.

49. A loss mitigation tool according to claim 44, wherein the insured entity is not required to pay compensation for the provision of the data protection service beyond what the insurer would ordinarily charge for insuring the insured entity against losses arising out of lost data.

50. A loss mitigation tool according to claim 49, wherein the insurance agreement includes a condition that the insured entity is responsible for using the data protection service if the insured entity is to recover under the insurance agreement, and wherein the insurance is not provided if the condition is not satisfied.

51. An insurance and data protection system comprising:
a provider; and
a data owner;
wherein the provider provides a data protection service to the data owner; and
wherein the provider insures the data owner against losses arising out of lost data.

52. A system according to claim 51, wherein the data owner is required by the provider to use the data protection service.

53. A system according to claim 51, wherein the insurance of the data owner against losses arising out of lost data is at least partially contingent upon the data owner's using predetermined data protection services provided by the provider.

54. A system according to claim 51, wherein the provider provides a data backup service, and further comprising:
apparatus operable to create a backup copy of the data owner's data at a location controlled by the provider; and
apparatus operable to generate, after a loss of the data owner's data, a further copy of the data owner's data from the backup copy.

55. A system according to claim 54, wherein the data backup service is an online data backup service.

56. A system according to claim 51, wherein the data owner is not required to pay a premium to the provider, beyond what the provider would ordinarily charge for providing insurance without the provision of the data protection service.
